(19) United States
(12) Patent Application Publication
(10) Pub. No.: US 2011/0216103 A1
(43) Pub. Date: Sep. 8, 2011

(54) LIQUID CRYSTAL DISPLAY DEVICE

(75) Inventor: Takahiro NAGAMI, Mobara (JP)

(73) Assignee: Hitachi Displays, Ltd.

(21) Appl. No.: 13/038,516

(22) Filed: Mar. 2, 2011

(30) Foreign Application Priority Data
Mar. 4, 2010 (JP) 2010-047703

(51) Int. Cl. G09G 3/36; G09G 5/10

(52) U.S. Cl. 345/690; 345/89

(57) ABSTRACT

There is provided a liquid crystal display device using line inversion driving for inverting the polarity of gray scale voltage every N lines. The display device includes: drain lines extending in a first direction and arranged in parallel in a second direction; gate lines extending in the second direction and arranged in parallel in the first direction; a pixel electrode formed in a pixel area; and a common electrode disposed opposite to the pixel electrode. An image signal after polarity inversion is input to the pixels adjacent to each other in the first direction in every N-th line. A first pixel electrode is provided in pixels at least in one line to which the image signal immediately after polarity inversion is input. A second pixel electrode is provided in the other pixels. The area of the first pixel electrode is larger than the second pixel electrode to prevent display quality degradation.

### CLAIM OF PRIORITY

The present application claims priority from Japanese Patent Application JP 2010-047703 filed on Mar. 4, 2010, the content of which is hereby incorporated by reference into this application.

### FIELD OF THE INVENTION

The present invention relates to a liquid crystal display device, and more particularly to a liquid crystal display device using a polarity inversion driving for inverting the gray scale voltage applied to pixels every two or more lines.

### BACKGROUND OF THE INVENTION

A liquid crystal display device supplies a gray scale voltage (image signal, drain signal) supplied from an image signal drive circuit (drain driver), to image signal lines (drain lines) within a display area through lines (leader lines). The image signal from the drain line is supplied to a storage capacitance of each pixel through a thin film transistor. Then, an image is displayed in accordance with the image signal. At this time, each of the line and the drain line has a parasitic load by a path from a driver IC. The size of the parasitic load greatly depends on the wiring distance, the wiring width, and the physical value of the wiring material. Further, a conventional liquid crystal display device has a multi-layer structure using wiring materials with different physical values to form a narrow frame. The image signal output from the image signal drive circuit is influenced by the parasitic load. The greater the load the more distorted the waveform of the image signal at the rising and falling edges. In other words, the image signal in a so-called dulled state is supplied to the thin film transistor. Because of the structure of the thin film transistor, insufficient writing occurs in a gate pulse (scan signal) at the rising and falling edges, resulting in a lower voltage to be written to the pixel than the image signal voltage. The amount of such a voltage reduction (voltage change) due to insufficient writing increases, as the greater the parasitic load on the line and on the drain line, the more the rising waveform of the image signal is dulled, and thus, the more insufficient the voltage writing is.

Meanwhile, there is known a dot inversion driving method for driving the liquid crystal of the liquid crystal display device by an AC voltage. The dot inversion driving method applies an image signal to electrodes of pixels (pixel electrodes) by inverting the polarity of the image signal for each pixel, using a common voltage applied to a common electrode as a reference. Thus, in the dot inversion driving method, it is necessary to invert the polarity of the image signal for each pixel. For this reason, when the parasitic load on the lines and drain lines increases, there is a concern that insufficient writing may occur in all pixels and that the display quality may be degraded.

To solve this problem, an N-line inversion driving method has been proposed to invert the image signal to be applied to each pixel electrode for every N (N≧2) lines. However, also in the N-line inversion driving method, insufficient writing is likely to occur in the pixels in the line immediately after being subjected to polarity inversion, than in the pixels in the next line. Voltage reduction may occur due to the insufficient writing, causing image defects such as stripe-like unevenness and flicker, and there is a concern that the display quality will be significantly degraded. As a method for solving this problem, for example; there is a technology described in JP-A No. 207760/2003. In the technology of JP-A No. 207760/2003, the period for outputting the image signal to the pixels in the line immediately after being subjected to polarity inversion, is longer than the period for outputting the image signal to the pixels in the next line.

### SUMMARY OF THE INVENTION

In the market for medium-and small-sized liquid crystal display devices mounted on small mobile devices such as mobile phones, there is an increasing demand for a large display area within a limited case size as well as high image quality. The demand is likely to be met by increasing the length of drain lines, by increasing the number of thin film transistors coupled to one drain line, and by increasing the length and number of lines for coupling the drain lines and the image signal drive circuit. As a result, however, the parasitic load on the lines and drain lines would significantly increase in pixels located at far end of the image signal drive circuit. In particular in the technology described in JP-A No. 207760/2003, if the parasitic load on the lines and drain lines significantly increases, it is necessary to significantly increase the drive capability of the image signal drive circuit, namely, the output voltage supply capability. This may lead to a significant increase in the load on the image signal drive circuit, such as an increase in the power consumption of the image signal drive circuit.

The present invention addresses the above identified problems by providing a liquid crystal display device capable of preventing display quality degradation in line inversion driving for inverting the polarity of the gray scale voltage every N (N≧2) lines.

In order to solve the above problems, the present invention provides a liquid crystal display device including drain lines, gate lines, a pixel electrode formed in the area of a pixel surrounded by the drain lines and the gate lines, and a plate-like common electrode disposed opposite to the pixel electrode at least in each pixel. The drain lines extending in a first direction are arranged in parallel in a second direction. The gate lines extending in the second direction are arranged in parallel in the first direction. An image signal after inversion of the polarity of the gray scale voltage to be output to each pixel, is supplied to the pixels adjacent to each other in the second direction. At the same time, an image signal after inversion of the polarity of the gray scale voltage to be output to each pixel, is supplied to the pixels adjacent to each other in the first direction in every N (N≧2)th line. Further, the liquid crystal display device also includes a first electrode and a second electrode. Of the pixels adjacent to each other in the first direction, the first pixel electrode is provided in pixels at least in one line to which the image signal is input immediately after inversion of the polarity of the gray scale voltage. The second pixel electrode is different from the first pixel electrode in the electrode area. The area of the first pixel electrode is larger than the area of the second pixel electrode.

According to the present invention, it is possible to prevent display quality degradation even in a liquid crystal display device using the line-inversion driving method to invert the polarity of the gray scale every N (N≧2) lines.

These and other advantages of the present invention will be appreciated from the detailed description and examples which are set forth herein.

### BRIEF DESCRIPTION OF THE DRAWINGS

FIG. 1 is a schematic diagram showing the general configuration of a liquid crystal display device according to a first embodiment of the present invention;

FIGS. 2A and 2B are views showing the relationship between the pixel drive method and the pixel configuration in the liquid crystal display device according to the first embodiment of the present invention;

FIG. 3 is a view showing the voltage reduction when an image signal without distortion is input to the pixels of the liquid crystal display device;

FIG. 4 is a view showing the voltage reduction when an image signal with distortion is input to the pixels of the liquid crystal display device;

FIG. 5 is a view showing the polarity of the pixels in dot inversion driving;

FIG. 6 is a view showing the polarity of the pixels in 2-line dot inversion driving;

FIG. 7 is a view showing the polarity of the pixels in 4-line dot inversion driving;

FIG. 8 is a view showing the detailed configuration of the pixel electrode in a liquid crystal display device according to a second embodiment of the present invention;

FIG. 9 is a view showing the detailed configuration of pixel electrodes in a liquid crystal display device according to a third embodiment of the present invention;

FIG. 10 is a view showing the detailed configuration of pixel electrodes in a liquid crystal display device according to a fourth embodiment of the present invention; and

FIG. 11 is a view showing another detailed configuration of pixel electrodes in the liquid crystal display device according to the fourth embodiment of the present invention.

### DETAILED DESCRIPTION OF THE PREFERRED EMBODIMENTS

Hereinafter embodiments to which the present invention is applied will be described with reference to the accompanying drawings. In the following description, corresponding components are identified by the same reference numerals and the description will not be repeated.

### First Embodiment

### <General Configuration>

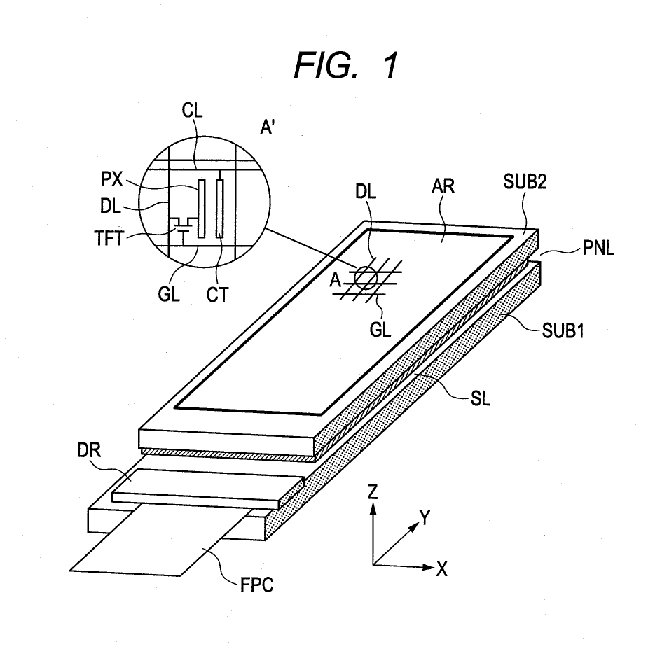

FIG. 1 is a schematic diagram showing the general configuration of a liquid crystal display device according to a first embodiment of the present invention. In FIG. 1, reference symbols X, Y, and Z denotes X axis, Y axis, and Z axis, respectively. In the following description, it is assumed that the present invention is applied to an IPS type liquid crystal display device. However, it is to be understood that the present invention can also be applied to a VA type liquid crystal display device.

As shown in FIG. 1, the liquid crystal display device of the first embodiment includes a liquid crystal display panel PNL. The liquid crystal display panel PNL includes a first substrate SUB1, a second substrate SUB2 disposed opposite to the first substrate SUB1, and a liquid crystal layer, not shown, disposed between the first substrate SUB1 and the second substrate SUB2. The first substrate SUB1 is a substrate on which pixel electrodes and the like are formed. The second substrate SUB2 is a substrate on which color filters and black matrices are formed. Further, a backlight unit is provided in the liquid crystal display panel PNL to function as a light source of the liquid crystal display device. A sealing material SL is applied around the periphery of the second substrate SUB2 to fix the first substrate SUB1 and the second substrate SUB2 together. In this way, the liquid crystal is sealed between the first and second substrates SUB1, SUB2. It is to be noted that in the following, the liquid crystal display panel PNL will be referred to as the liquid crystal display device even in the description of the liquid crystal display panel PNL.

As is well known, for example, glass substrates are generally used as the first and second substrates SUB1 and SUB2. However, the substrates are not limited to the glass substrates, and may also be other insulating substrates such as quartz glass and plastic (resin) substrates. For example, when quartz glass is used for the first and second substrates SUB1 and SUB2, the process temperature can be increased, and a gate insulating film of the thin film transistor, described below, can be densified. As a result, the reliability can be increased. While plastic (resin) substrates can provide a light weight liquid crystal display device with an excellent impact resistance.

Further, in the liquid crystal display device of the first embodiment, a display area AR is the area in which display pixels (hereinafter simply referred to as pixels) are formed in the liquid crystal sealing area. In other words, even in the liquid crystal sealing area, the area in which no pixel is formed and which is not involved in display operation, is not the display area AR.

In the liquid crystal display device of the first embodiment, scan lines (gate lines) GL and image signal lines (drain lines) DL are formed on the surface of the first substrate SUB1 on the liquid crystal side in the display area AR. In FIG. 1, the gate lines GL extending in the x direction are arranged in parallel in the y direction, and the drain lines DL extending in the y direction are arranged in parallel in the x direction.

A rectangular area surrounded by the drain lines DL and the gate lines GL is the area in which a pixel is formed. In this way, pixels are arranged in a matrix form in the display area AR. For example, as shown in A′ which is an enlarged view of the circle A of FIG. 1, each pixel includes a thin film transistor TFT, a pixel electrode PX, and a common electrode CT. The thin film transistor TFT is turned on by a scan signal from the gate line GL. The pixel electrode PX is supplied with an image signal from the drain line DL through the thin film transistor TFT being turned on. The common electrode CT is coupled to a common line CL, to which a common signal is supplied. At this time, the common signal has a potential used as a reference of the potential of the image signal. The common electrode CT shown in the enlarged view A′ is configured such that the common signal is input to the common electrode CT independently formed for each pixel through the common line CL. However, the common electrode CT is not limited to this configuration, and may also be configured such that the common electrodes CT of the pixels adjacent to each other in the x direction are formed to be directly coupled to each other, so that the common signal is input from one or both of the left and right ends of the first substrate SUB1 in the x direction through the common line CL.

Each of the drain lines DL and the gate lines GL extends beyond the sealing material SL at an end of each line, and is coupled to a drive circuit DR. The drive circuit DR is formed by a semiconductor chip. The drive circuit DR is mounted on the liquid crystal surface side of the first substrate SUB1 that is larger than the second substrate SUB2. As described above, in the liquid crystal display device of the first embodiment, the drive circuit DR is formed by a semiconductor chip on the first substrate SUB 1. However, it is also possible that the image signal drive circuit for outputting the image signal, or a scan signal drive circuit for outputting the scan signal is, or both of them are mounted on a flexible print substrate FPC by a tape carrier method or a chip on film (COF) method. Then, one of the drive circuits is or both of them are coupled to the first substrate SUB1.

Further, the drive circuit DR of the first embodiment outputs the gray scale voltage as the image signal to the drain lines DL in the following manner. With respect to the x direction, the gray scale voltage is output as the image signal so that the polarity is inverted for each of the pixels next to one another, namely, the polarity is inverted for each of the adjacent pixels. With respect to the y direction, the gray scale voltage is output as the image signal so that the polarity is inverted every N pixels (where N is a natural number of 2 or more), namely, the polarity is inverted for the pixels in every N-th line. Further, the drive circuit DR outputs the scan signal to each gate line GL sequentially from the lower left side to the upper right side in FIG. 1. In other words, the drive circuit DR outputs the scan signal to each gate line GL sequentially from the bottom to the top of the liquid crystal display panel PNL. In this way, the drive circuit DR scans the gate lines GL from the bottom to the top of the liquid crystal display panel PNL. It is to be noted that the drive direction of the scan lines of the liquid crystal display panel PNL is not limited to the above example. It is also possible that the scan lines are driven from the top to the bottom of the liquid crystal display panel PNL.

### <General Configuration of the Pixels>

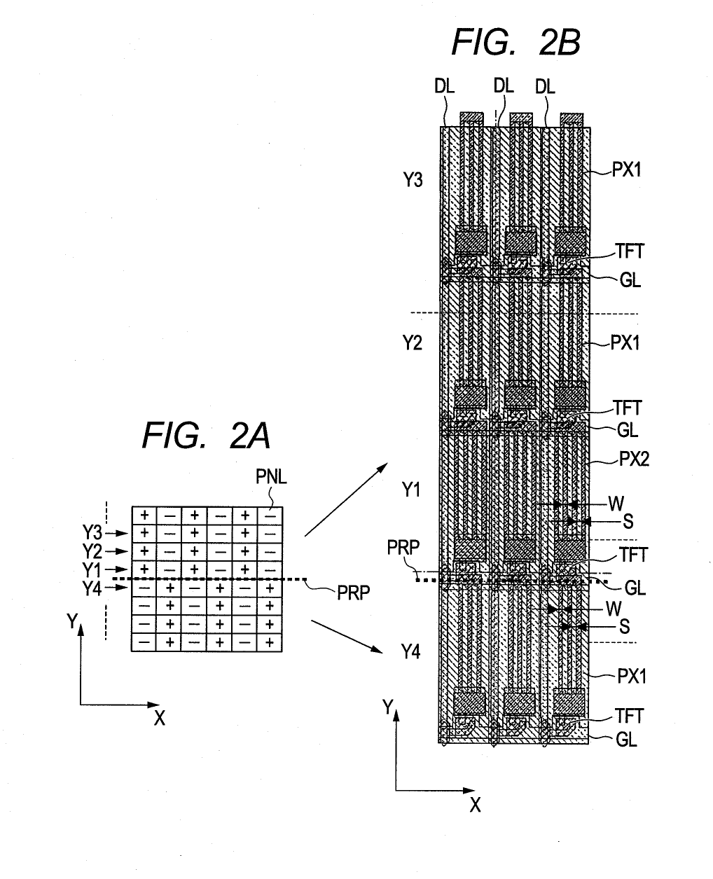

FIGS. 2B and 2A are views showing the relationship between the pixel drive method and the pixel configuration in the liquid crystal display device according to the first embodiment of the present invention. In particular, FIG. 2A is a view showing the pixel drive method in the liquid crystal display device of the first embodiment. FIG. 2B is a view showing the detailed configuration of the pixels in the liquid crystal display device of the first embodiment. In FIG. 2A, the “+” sign indicates a positive polarity pixel in which the image signal (gray scale voltage) applied to the pixel electrode exceeds the voltage applied to the common electrode. The “−” sign indicates a negative polarity pixel in which the image signal applied to the pixel electrode is below the voltage applied to the common electrode.

It is to be noted that the pixel configuration of the liquid crystal display device of the first embodiment is the same as the conventional pixel configuration, except for the configuration of the pixel electrode. Thus, the configuration of the pixel electrode will be described in detail below. In the following description, it is assumed that the image signal is applied so that the polarity is inverted for the pixels in every N=4th line. However, N may be any natural number of 2 or more. Further, the configurations of the pixel electrode PX1 and the pixel electrode PX2 are the same with only a difference in the number of linear electrodes forming the pixel electrode PX, namely, the number of slits. Thus, in the following, both of the pixel electrodes PX1 and PX2 are appropriately referred to as pixel electrodes PX even in the description of the pixel electrodes PX1 and PX2.

As shown in FIG. 2B, in the liquid crystal display device of the first embodiment, a plurality of drain lines DL extending in the Y direction are arranged in parallel in the x direction on the first substrate SUB1. Further, a plurality of gate lines GL extending in the x direction are arranged in the y direction on the first substrate SUB1. Each area surrounded by the gate lines GL and the drain lines DL constitutes a pixel area. With this configuration in the liquid crystal display device of the first embodiment, the pixels are arranged in a matrix form. Further, in the liquid crystal display device of the first embodiment, for example, the plate-like common electrode, not shown, is formed on the surface (opposite surface) on the liquid crystal side of the first substrate SUB1. The common electrode is formed by a transparent conductive material such as indium-tin-oxide (ITO). The common electrode is formed so as to overlap the common line, not shown, in a side portion of the first substrate SUB1. In this way, the common electrode is electrically coupled to the common line. It is to be noted that in the first embodiment, the gate lines GL and the drain lines DL are formed by a metal thin film, but the material is not limited to this example.

Further, in the liquid crystal display device of the first embodiment, the thin film transistor TFT is formed for each pixel in the lower portion of the particular pixel area in the figure. A lead portion extends from a portion of the drain line DL extending in the y direction, to the side of the thin film transistor TFT. Thus, the drain line DL is coupled to the drain electrode of the thin film transistor TFT through the lead portion. Further, the thin film transistor TFT of the first embodiment has a structure in which a semiconductor layer is formed on the upper layer of the gate line GL. In other words, the thin-film transistor TFT is formed to be a metal insulator semiconductor (MIS) transistor having a so-called inversely staggered structure, using the gate signal line GL as the gate electrode of the thin film transistor TFT. The MIS transistor is driven so as to switch between the drain electrode and the source electrode by the application of bias voltage. However, in the present specification, the side coupled to the drain line DL is referred to as drain electrode, and the side coupled to the pixel electrode PX is referred to as source electrode for convenience of the description.

Further, a protective layer, not shown, is formed on the surface on the liquid crystal side of the first substrate SUB1. The protective layer is formed by an insulating film covering the thin film transistor TFT. The protective layer prevents the thin film transistor TFT from directly coming into contact with the liquid crystal. In addition, the protective layer facilitates the planarization of the surface of the first substrate, which is associated with the formation of the thin film transistor TFT. Further, the common electrode is formed on the top surface of the protective layer. Then, a capacitor insulating film is formed on the upper layer to function as a dielectric film of a capacitor. Then, the pixel electrode PX is formed on the upper layer through the capacitor insulating film, in which the storage capacitance of each pixel is formed. At this time, a contact hole is formed in the capacitor insulating film and the protective layer. The contact hole extends to a pad portion. The pixel electrode PX and the thin film transistor TFT are electrically coupled to each other through the contact hole.

### <Detailed Configuration of the Pixels>

As shown in FIG. 2A, the liquid crystal display device of the first embodiment rewrites each pixel from the bottom to the top of the liquid crystal display panel in the y direction in the figure. For example, with respect to the pixel row indicated by X1, the negative pixel is arranged for 4 lines (pixels) from the bottom of the liquid crystal display panel, and the positive polarity pixel is arranged for 4 lines (pixels) above the line indicated by the dotted line PRP. At this time, the polarity of the image signal is inverted for each pixel in the x-direction. Thus, with respect to the pixel row indicated by X1, the positive pixel is arranged for 4 lines (pixels) from the bottom of the liquid crystal display panel, followed by the negative pixel for four lines. In FIG. 2A, after the pixels in one line indicated by Y4 are rewritten in the x direction, the pixels in one line indicated by Y1 are rewritten in the x direction. At this time, in the liquid crystal display device of the first embodiment, the liquid crystal display panel is driven by the 4-line dot inversion driving method. In other words, the pixels in one line indicated by Y1 are rewritten by supplying the image signal after polarity inversion to each pixel in the x direction. Then, the pixel lines indicated by Y2 and Y3 are sequentially rewritten with the polarity arrangement as shown in FIG. 2A. The other pixels are rewritten with the same polarity arrangements as described above. In other words, with respect to the x direction, the image signal after polarity inversion is supplied to every four lines, namely, every four pixels. With respect to the x direction, the image signal after polarity inversion is supplied to each pixel.

In the liquid crystal display device of the first embodiment, as shown in FIG. 2B, the image signal with the same polarity as in the previous line, namely, the image signal immediately after polarity inversion is not input to the pixel electrode PX corresponding to each of the pixels in one line indicated by Y4 in the x direction. At this time, the pixel electrode PX is formed as a pixel electrode PX1 by three linear electrodes with an electrode width W and an electrode distance S. On the other hand, the image signal immediately after polarity inversion is input to the pixel electrode PX corresponding to each of the pixels in one line indicated by Y1 in the x direction. At this time, the pixel electrode PX is formed as a pixel electrode PX2 by four linear electrodes with the electrode width W and the electrode distance S. Further, the image signal not immediately after polarity inversion is input to the pixel electrode PX corresponding to each of the pixels in one line indicated by Y2 or Y3 in the x direction. In this case, similarly to the pixel electrode PX1 corresponding to the pixels in one line indicated by Y4 in the x direction, the pixel electrode PX is formed as the pixel electrode PX1 by three linear electrodes with the electrode width W and the electrode distance S.

As described above, in the liquid crystal display device of the first embodiment, the pixel electrodes PX have the same configuration in the pixels coupled to the same gate line GL through the gate electrodes of the thin film transistors TFT, namely, the pixels arranged in one line in the x direction. At this time, the pixel electrodes PX2 of the pixels in one line, to which the image signal immediately after polarity inversion is input, each include four linear electrodes. On the other hand, the pixel electrode PX1 of the pixels, to which the image signal immediately after polarity inversion is not input, each include three linear electrodes. As described above, in the liquid crystal display device of the first embodiment, the pixel electrode PX1 corresponds to each of the pixels in the first to third lines to which the image signal is input with the same polarity as the polarity in the previous line. In this case, the number of linear electrodes forming the pixel electrode PX1 is three. On the other hand, the pixel electrode PX2 corresponds to each of the pixels in the fourth line to which the image signal is input with a polarity different from the polarity in the previous line. In this case, the number of linear electrodes forming the pixel electrode PX2 is four. With this configuration, in the liquid crystal display device of the first embodiment, the area of the pixel electrode PX2 in the line to which the image signal immediately after polarity inversion is input, is larger than the area of the PX1 in the line to which the image signal not immediately after polarity inversion is input. As a result, the storage capacitance formed by the common electrode and the pixel electrode in each pixel of the line to which the image signal immediately after polarity inversion is input, is larger than the storage capacitance in the pixels of the other lines. This makes it possible to reduce the difference between the voltage reduction in the pixels in the line to which the image signal immediately after polarity inversion is input, and the voltage reduction in the other pixels. Thus, also in the line inversion driving in which the polarity of the image signal is inverted every four lines, it is possible to prevent the occurrence of image defects such as stripe-like unevenness and flicker, and to prevent display quality degradation.

### <Description of the Effects>

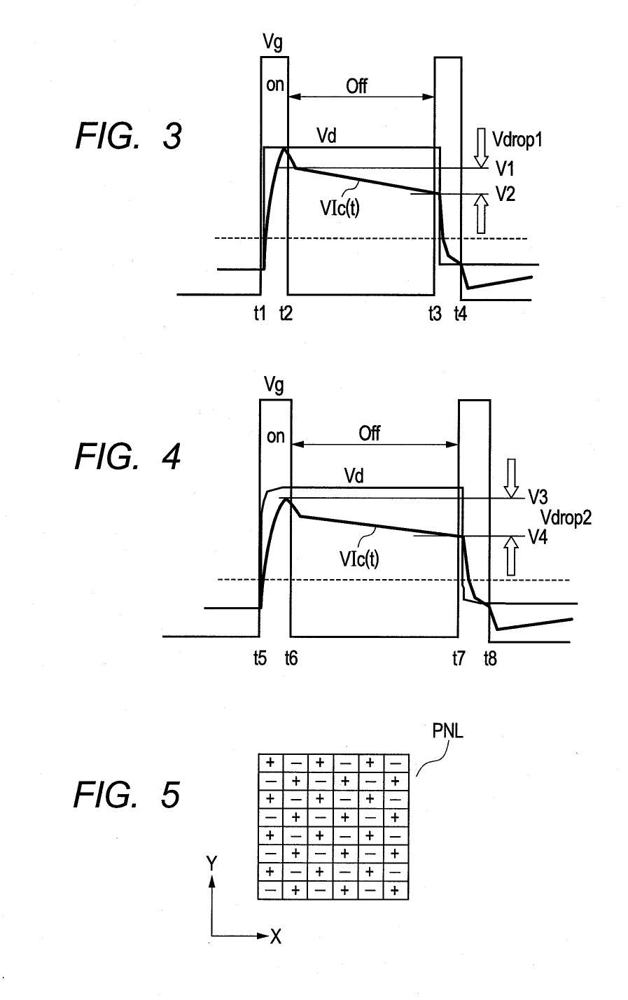

FIG. 3 is a view showing the voltage reduction in the pixel electrode voltage when an image signal without distortion is input to the pixel of the liquid crystal display device. FIG. 4 is a view showing the voltage reduction in the pixel electrode voltage when an image signal with distortion is input to the pixel of the liquid crystal display device.

FIG. 3 shows the case in which a scan signal (gate signal) Vg as well as an image signal Vd without distortion are input at a time t1. In this case, a desired pixel voltage set in advance by the image signal Vd is written to the storage capacitance during the high period of the scan signal from the time t1 to a time t2, namely, during the ON period of the thin film transistor. When the high period of the scan signal Vg ends and the thin film transistor is turned off, the voltage is reduced by a field-through voltage to a voltage V1. Then, when the scan signal is input in the next frame period at a time t3 after the OFF period of the thin film transistor, the voltage is reduced to a voltage V2. Thus, the difference in the reduction between V1 and V2 represents a voltage reduction Vdrop (hereinafter referred to as Vdrop 1) for the case in which the scan signal Vd without distortion is input.

While FIG. 4 shows the case in which the scan signal (gate signal) Vg as well as a so-called dulled image signal Vd in which distortion occurs, are input at a time t5. The pixel voltage is written in the storage capacitance by the image signal Vd during the high period of the scan signal from the time t5 to a time t6, namely, during the ON period of the thin film transistor TFT. In this case, however, insufficient writing occurs. When the image signal is dulled at the rising edge at the time t5 and the thin film transistor is turned off at a time t6, the voltage is reduced by the filed through voltage to V3. Then, when the pixel electrode is written in the next frame period at a time t7 after the OFF period of the thin film transistor, the voltage is reduced to V4. Thus, the difference in the voltage reduction between V3 and V4 represents a voltage reduction Vdrop (hereinafter referred to as Vdrop 2) for the case in which the dulled image signal Vd is input.

Thus, in the so-called dulled state in which distortion occurs in the rising or falling edge of the image signal Vd, the voltage is reduced not only by the voltage associated with the liquid crystal driving but also by the field through voltage. As a result, the voltage reduction Vdrop 2 is greater than Vdrop 1.

In this case, as shown in FIG. 5, if the dot inversion driving is performed to invert the polarity for each pixel in the y direction, the voltage reduction Vdrop 2 shown in FIG. 4 occurs in all the pixels. Thus, it is possible to prevent the occurrence of defects such as stripe-like unevenness and flicker caused by voltage reduction due to insufficient writing. However, the voltage reduction Vdrop 2 is so large that the whole display quality is degraded. In addition, the polarity is inverted for each pixel both in the y and x directions, so that the electrode consumption increases.

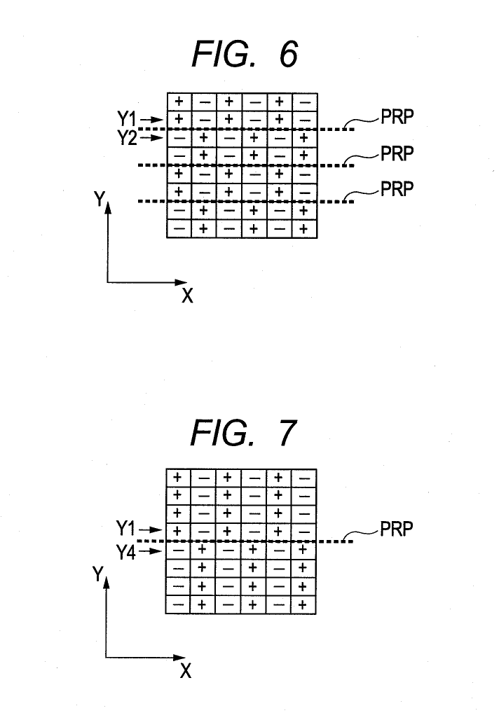

FIG. 6 shows the case in which the 2-line dot inversion driving is performed to invert the polarity of the image signal to be applied to the pixels every two lines. In this case, the pixels of the voltage reduction Vdrop 1 shown in FIG. 3, and the pixels of the voltage reduction Vdrop 2 shown in FIG. 4, are adjacent to each other in the y direction. As a result, stripe-like unevenness occurs in the position of the dotted line PRP. Similarly, in the case of the 4-line dot inversion driving shown in FIG. 7, stripe-like unevenness occurs in the position of the dotted line PRP. However, the electrode consumption can be reduced as the number of pixels (the number of lines) to be subjected to polarity inversion can be reduced compared to the case of the dot inversion driving. In particular, the more the number of lines with the same polarity as in the previous line, the more the electrode consumption can be reduced. For this reason, the electrode consumption in the 4-line dot inversion driving can be reduced compared to the 2-line dot inversion driving.

In the liquid crystal display device according to the present invention, the number of linear electrodes of the pixel to which the image signal immediately after polarity inversion is input, is greater than the number of linear electrodes of the other pixels. As a result, the storage capacitance can be greater in the pixel with the greater number of linear electrodes, than the storage capacitance of the other pixels.

Here, the voltage reduction Vdrop in the liquid crystal pixel can be expressed by the following equation: Vdrop=ΔVg×Cgs/(Cgs+Clc+Cstg), where the gate-source capacitance is represented by Cstg, the liquid crystal capacitance by Clc, the storage capacitance by Cstg, and the amplitude of the gate signal (scan signal) by ΔV. Thus, in the liquid crystal display device according to the present invention, the amount of increase in the voltage reduction Vdrop (Vdrop 3-Vdrop 4) in the case of the dulled waveform due to the waveform distortion of the image signal, can be limited to the amount of increase in the storage capacitance. As a result, even if the polarity of the image signal is inverted every two or more lines, it is possible to prevent the occurrence of defects such as stripe-like unevenness and flicker in the position of the dotted line PRP. Thus, the image quality degradation can be prevented.

In the liquid crystal display device of the first embodiment, the number of linear electrodes of the pixel electrode PX2 of all the pixels to which the image signal immediately after polarity inversion is input every 4 lines, is greater than the number of linear electrodes of the pixel electrode PX1 of the other pixels. However, the present embodiment is not limited to this configuration. For example, only the pixel electrode in the pixels to which the image signal immediately after polarity inversion is input and which are located in the area distant from the output of the drive circuit (the image signal drive circuit), is defined as the pixel electrode PX2 with a larger number of linear electrodes than the number of linear electrodes of the pixel electrode PX1 of the other pixels.

### Second Embodiment

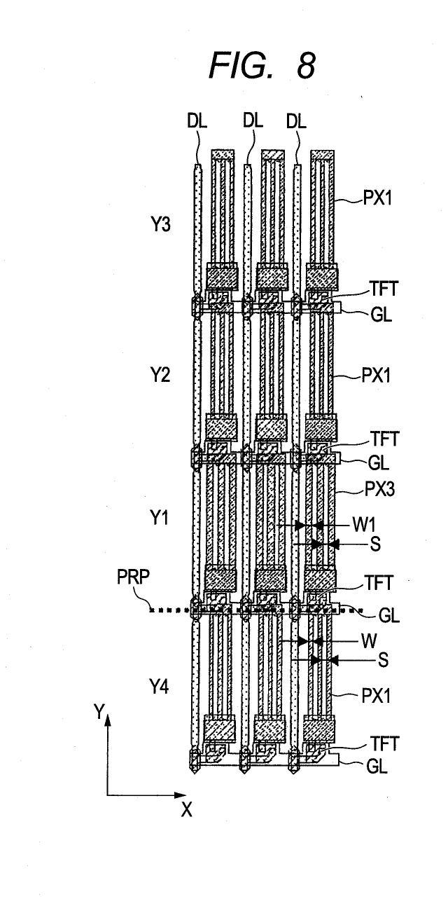

FIG. 8 is a view showing the detailed configuration of the pixel electrodes in a liquid crystal display device according to a second embodiment of the present invention. However, the liquid crystal display device of the second embodiment has the same configuration as that of the first embodiment, except for the configuration of a pixel electrode PX3. Thus, the configuration of the pixel electrode PX3 will be described in detail below.

As apparent from FIG. 8, in the liquid crystal display device of the second embodiment, the pixel electrode PX3 includes three linear electrodes with an electrode width W1 (where W1>W) and an electrode distance S. In other words, in the liquid crystal display device of the second embodiment, the configuration of the pixel electrode PX3 is different from the configuration of the pixel electrode PX1, with the number of linear electrodes unchanged. Of the pixels arranged in the y direction, the pixel electrode PX3 is provided in the pixels indicated by Y1 above the dotted line PRP in the figure, to which the image signal immediately after polarity inversion is input. The pixel electrode PX1 is provided in other lines indicated by Y2 to Y4. In particular, in the second embodiment, the distance between the linear electrodes, or the slit width S, is the same in the pixel electrode PX1 and in the pixel electrode PX3. On the other hand, the linear electrode width of the pixel electrode PX1 has the linear electrode width W, and the pixel electrode PX3 has the linear electrode width W1 that is wider than the linear electrode width W of the pixel electrode PX1. With this configuration, the storage capacitance of the pixel including the pixel electrode PX3 is greater than the storage capacitance of the pixel including the pixel electrode PX1.

Thus, also in the liquid crystal display device of the second embodiment, the same effect as the first embodiment can be obtained. At this time, because the liquid crystal display device of the second embodiment is configured to change the electrode width W1 between the linear electrodes forming the pixel electrode PX3, it is possible to obtain a special effect of being able to finely adjust the degree of the change in the storage capacitance formed by the common electrode and the pixel electrode in each pixel.

As a result, for example, even for the pixels to which the image signal immediately after polarity inversion is input in the same liquid crystal display panel, it is possible to finely adjust the electric charge stored in the storage capacitance, namely, it is possible to finely adjust the voltage reduction, by changing the electrode width of the linear electrodes forming the pixel electrode PX3 so that pixels in the far end of the drive circuit, and pixels located in the center have different linear electrode widths.

### Third Embodiment

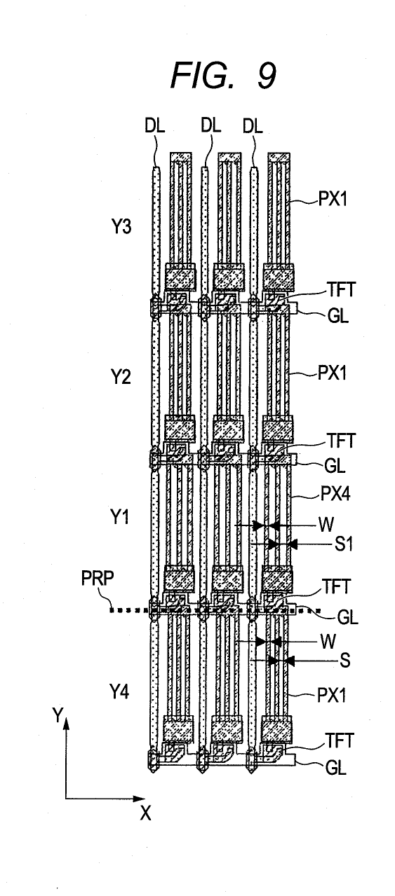

FIG. 9 is a view showing the detailed configuration of the pixel electrodes in a liquid crystal display device according to a third embodiment of the present invention. However, the liquid crystal display device of the third embodiment has the same configuration as that of the first embodiment, except for the configuration of a pixel electrode PX4. Thus, the configuration of the pixel electrode PX4 will be described in detail below.

As apparent from FIG. 9, in the liquid crystal display device of the third embodiment, the pixel electrode PX4 includes three linear electrodes with an electrode width W and an electrode distance S1 (where S1>S). In other words, in the liquid crystal display device of the third embodiment, the configuration of the pixel electrode PX4 is different from the configuration of the pixel electrode PX1, with the number of linear electrodes unchanged. Of the pixels arranged in the y direction, the pixel electrode PX4 is provided in the pixels indicated by Y1 above the dotted line PRP in the figure, to which the image signal immediately after polarity inversion is input. The pixel electrode PX1 is provided in other lines indicated by Y2 to Y4. In particular, in the third embodiment, the linear electrode width W is the same in the pixel electrode PX1 and in the pixel electrode PX4. On the other hand, the pixel electrode PX1 has the linear electrode distance or slit width S, and the pixel electrode PX4 has the linear electrode distance or slit width 51 that is greater than the linear electrode distance S of the pixel electrode PX1. With this configuration, the storage capacitance of the pixel including the pixel electrode PX4 is greater than the storage capacitance of the pixel including the pixel electrode PX1.

Thus, also in the liquid crystal display device of the third embodiment, the same effect as the first embodiment can be obtained. At this time, because the liquid crystal display device of the third embodiment is configured to change the electrode distance S1 between the linear electrodes forming the pixel electrode PX4, it is possible to obtain a special effect of being able to finely adjust the degree of the change in the storage capacitance formed by the common electrode and the pixel electrode in each pixel.

As a result, for example, even for the pixels to which the image signal immediately after polarity inversion is input in the same liquid crystal display panel, it is possible to finely adjust the electric charge stored in the storage capacitance, namely, it is possible to finely adjust the voltage reduction, by changing the distance between the linear electrodes forming the pixel electrode PX4 so that pixels located in the far end of the drive circuit, and pixels located in the center have different linear electrode distances.

In the liquid crystal display device according to the second and third embodiments, the electrode width or the electrode distance is changed with respect to the linear electrodes forming the pixel electrodes PX3 and PX4. However, the present invention is not limited to these embodiments, and both the electrode width and electrode distance may be changed with respect to the linear electrodes forming the pixel electrodes PX3 and PX4.

### Fourth Embodiment

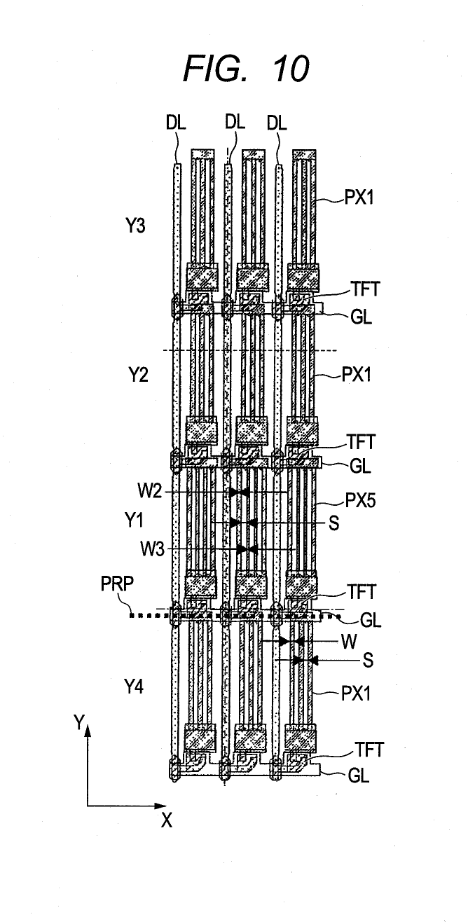

FIG. 10 is a view showing the detailed configuration of the pixel electrodes in a liquid crystal display device according to a fourth embodiment of the present invention. However, the liquid crystal display device of the fourth embodiment has the same configuration as that of the first embodiment, except for the configuration of a pixel electrode PX5. Thus, the configuration of the pixel electrode PX5 will be described in detail below.

As apparent from FIG. 10, in the liquid crystal display device of the fourth embodiment, the pixel electrode PX5 includes four linear electrodes with electrode widths W2, W3 (where W2>W3) and the electrode distance S. In other words, in the liquid crystal display device of the fourth embodiment, the configuration of the pixel electrode PX5 is different from the configuration of the pixel electrode PX1. Of the pixels arranged in the y direction, the pixel electrode PX5 is provided in the pixels indicated by Y1 above the dotted line PRP in the figure, to which the image signal immediately after polarity inversion is input. The pixel electrode PX1 is provided in other lines indicated by Y2 to Y4. In particular, in the fourth embodiment, the distance between the linear electrodes, or slit width S, is the same in the pixel electrode PX1 and in the pixel electrode PX5. On the other hand, in the pixel electrode PX5, the number of linear electrodes in the pixel electrode PX1 is changed to four with different electrode widths W2 and W3. At this time, the two linear electrodes with the electrode width W2 that is wider than the electrode width W3 are disposed adjacent to the drain lines DL, respectively. In this way, the two electrodes with the electrode width W3 are disposed between the two linear electrodes with the electrode width W2. With this configuration, the storage capacitance of the pixel including the pixel electrode PX5 is greater than the storage capacitance of the pixel including the pixel electrode PX1.

Thus, also in the liquid crystal display device of the fourth embodiment, the same effect as the first embodiment can be obtained. At this time, because the liquid crystal display device of the fourth embodiment is configured to change the electrode widths W2, W3 of the linear electrodes forming the pixel electrode PX5, it is possible to obtain a special effect of being able to finely adjust the degree of the change in the storage capacitance formed by the common electrode and the pixel electrode in each pixel.

As a result, for example, even for the pixels to which the image signal immediately after polarity inversion is input in the same liquid crystal display panel, it is possible to finely adjust the electric charge stored in the storage capacitance, namely, it is possible to finely adjust the voltage reduction, by changing the distance between the linear electrodes forming the pixel electrode PX5 so that pixels located in the far end of the drive circuit, and pixels located in the center have different linear electrode distances.

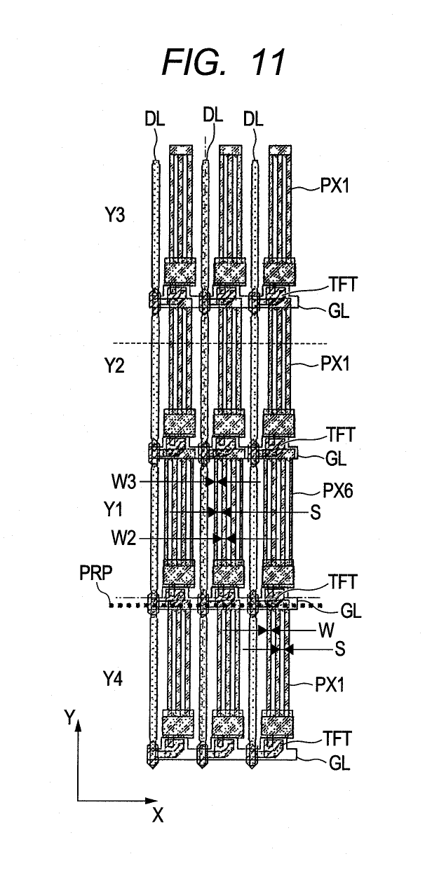

However, the arrangement of the linear electrodes with the different widths W2, W3 is not limited to the above example. As shown in FIG. 11, it is also possible to have another pixel electrode PX6 in which the linear electrodes with the electrode width W3 smaller than the electrode width W2 are disposed adjacent to the respective drain lines DL, so that the linear electrodes with the electrode width W2 are disposed between the linear electrodes with the electrode width W3. With this configuration, the storage capacitance of the pixel including the pixel electrode PX6 is larger than the storage capacitance of the pixel including the pixel electrode PX1.

In the liquid crystal display device of the fourth embodiment, the electrode distance S between the linear electrodes forming the pixel electrode PX5 or PX6 is set to constant. However, the present embodiment is not limited to this configuration, and it is also possible to change the electrode distance between the linear electrodes forming the pixel electrode PX5 or PX6.

Further, the fourth embodiment may also be configured to set the number of linear electrodes forming the pixel electrode PX5 or PX6 to three, which is the same number as in the other pixel electrode. At this time, one of the three linear electrodes has the electrode width W2 and the other two linear electrodes have the electrode width W3, or vice versa.

In the liquid crystal display device according to the first to fourth embodiments of the present invention, the numbers of linear electrodes forming the pixel electrodes are set to three and four. However, the present invention is not limited to these examples. The number of linear electrodes can be appropriately changed according to other forms and sizes of pixels.

The present invention made by the present inventors has been described in reference to its embodiments. However, the present invention is by no means limited to the above embodiments, but can be changed or modified without departing from the scope of the present invention.

What is claimed is:

1. A liquid crystal display device comprising:
drain lines extending in a first direction and arranged in parallel in a second direction;
gate lines extending in the second direction and arranged in parallel in the first direction;
a pixel electrode formed in the area of a pixel surrounded by the drain lines and the gate lines; and
a plate-like common electrode disposed opposite to the pixel electrode at least in each pixel,
wherein an image signal after inversion of the polarity of the gray scale voltage to be output to each pixel, is supplied the pixels adjacent to each other in the second direction,
wherein an image signal after inversion of the polarity of the gray scale voltage to be output to each pixel, is supplied to the pixels adjacent to each other in the first direction in every N-th (N≧2) line,
wherein the liquid crystal display device further includes a first electrode and a second electrode,
wherein, of the pixels adjacent to each other in the first direction, the first pixel electrode is provided in pixels at least in one line to which the image signal is input immediately after inversion of the polarity of the gray scale voltage,
wherein the second pixel electrode is different from the first pixel electrode in the electrode area, and
wherein the area of the first pixel electrode is larger than the area of the second pixel electrode.

2. The liquid crystal display device according to claim 1, wherein the first and second pixel electrodes are linear electrodes formed so as to overlap the common electrode through a capacitor insulating film formed on the upper layer of the common electrode in the area of each pixel.

3. The liquid crystal display device according to claim 2, wherein the first and second pixel electrodes include a plurality of linear electrodes as well as slits with the ends closed.

4. The liquid crystal display device according to claim 2, wherein the number of linear electrodes of the first pixel electrode is greater than the number of linear electrodes of the second pixel electrode.

5. The liquid crystal display device according to claim 2, wherein the electrode width of the linear electrodes of the first pixel electrode is greater than the electrode width of the linear electrodes of the second pixel electrode.

6. The liquid crystal display device according to claim 2, wherein the distance between the linear electrodes of the first pixel electrode is greater than the distance between the linear electrodes of the second pixel electrode.

7. The liquid crystal display device according to claim 2, wherein the linear electrodes of the first pixel electrode include at least a first linear electrode with a first electrode width, and at least a second linear electrode with a second electrode width.

8. The liquid crystal display device according to claim 2, wherein the linear electrodes of the first pixel electrode include at least linear electrodes disposed at a first electrode distance, and at least linear electrodes disposed at a second electrode distance.
